(19) United States
(12) Patent Application Publication
(10) Pub. No.: US 2017/0196657 A1
(43) Pub. Date: Jul. 13, 2017

(54) DENTAL DEVICE AND METHODS OF FORMING SAME

(71) Applicant: SEBL Group Limited, Leigh (GB)

(72) Inventors: Simon Nixon, Lowton (GB); Christopher Ronald Howarth, Wigan Lancashire (GB)

(21) Appl. No.: 15/314,344

(22) PCT Filed: May 29, 2015
(86) PCT No.: PCT/GB2015/051570

§ 371 Date: Nov. 28, 2016

(30) Foreign Application Priority Data
May 30, 2014 (GB) 1409682.0

(51) Int. Cl. A61C 5/20; A61C 13/20; A61C 13/34; A61C 13/00; A61C 5/30; A61C 13/267

(52) U.S. Cl. CPC A61C 5/20; A61C 5/30; A61C 13/267; A61C 13/34; A61C 13/0028; A61C 13/206

(57) ABSTRACT

A customized dental device for placement over the natural teeth of a user is disclosed, as well as various methods for forming such a device. The method expands on conventional methods of forming a cast replica and model integrating retaining features into either the cast replica or a temporary model to help the device naturally and seamlessly hold to the teeth of the user in a customized manner. Alternative methods of formation through injection molding are disclosed. In different embodiments, the device may be used as a veneer to improve appearance of the user's natural teeth and/or as a weight control device by governing food intake.

### BACKGROUND

Technical Field

The present invention relates generally to the field of dental devices and methods of making the same. More particularly, but not exclusively, the present invention concerns a dental device with improved retention performance on a patient's set of teeth and the method of obtaining the improved performance.

Description of the Related Art

It is known to provide dental devices to be worn by a patient in order to improve the appearance of an existing set of teeth and to provide dental reconstructions where there is loss of teeth/parts of teeth.

Over recent years, dental technology has moved on from typical reconstruction procedures which involved drilling into healthy tooth structures in order that reconstruction material could be mounted on or around the teeth. The invasiveness of these older techniques is not always pleasing to a patient and the result is not always easily reversible or replaceable in the event that the foundation teeth change over time.

More recent techniques have therefore focused on the less-invasive and reversible possibilities.

US2013/224691 discloses an appliance fabricated to improve the appearance of a patient's smile with a plurality of simulated teeth. The interior surfaces of each of the teeth closely fits and conforms to the surface of a patient's real teeth while the outer surfaces of each of the simulated teeth has an ideal surface configuration. The dental appliance provides the patient with the appearance of a perfect set of teeth and an ideal smile without a need to alter the dental structure of the patient's teeth. In this appliance, retention points are provided so as to be located close to the gingival tissue of a patient, since the appliance is shaped to fit around the natural mid-way bulging contours of a patient's teeth. The flexible nature of the thermoforming copolymer/acetyl resin used to form the appliance allows the retention points to reversibly flex outwardly in order to pass beyond the bulge when placing and removing the appliance.

To date, such non-permanent dental appliances/devices have achieved an acceptable retention capability on the understanding that certain sticky or chewy foods should generally be avoided when they are worn.

It is an object of the present invention to address one or more of the problems of the prior art as discussed herein or otherwise.

Therefore, it is now desired to provide a dental device with improved retention performance on a patient's set of teeth and the method of obtaining the improved performance.

### SUMMARY OF THE INVENTION

In a first aspect of the present invention there is provided a method of making a non-permanent dental device with improved retention capability on a patient's set of teeth, comprising the steps of: (a) preparing a cast replica from an original dental impression taken from the patient; and (b) forming the dental device using the cast replica as a model, wherein the method further comprises reducing one or more dimensions of the cast replica in one or more predetermined retention areas.

With this method, the provision of reduced dimensions on the cast replica makes the internal dimensions of the resultant dental device smaller than would otherwise be achieved with a conventional method. Accordingly, the fit of the dental device on the patient's teeth is tighter, which improves the retention capability of the device overall.

By ‘improved retention capability’ it is meant that the dental device has a greater capacity for remaining in place on a patient's set of teeth and has a reduced possibility of unintentional dislodgement when compared with conventionally-made dental devices.

By ‘non-permanent dental device’ it is meant that the dental device is intentionally removable/releasable by the patient, without the need for professional intervention. Importantly, the fitting of the dental device does not require invasive dental work (e.g. work requiring permanent modification of a patient's teeth, or work that may damage the teeth if forced removal was required).

Preferably, the method comprises reducing the dimension(s) by providing a reduced amount of cast material on the cast replica. Most preferably, the method comprises removing material from the cast replica prior to forming the device. Most preferably, the method comprises shaving cast material from the cast replica. With this method the reduction of the dimensions can be very precise.

Additionally or alternatively, the method comprises adding impression material to the original impression from the patient prior to preparing the cast replica to provide the reduced amount of cast material on the subsequently prepared cast replica. In this latter situation, the method may first comprise taking an original dental impression from a patient before step (a) and may comprise the addition of impression material to the original impression.

Most preferably, the method comprises selecting the predetermined areas comprise on the lingual surface (on a lower/mandibular cast replica), or the palatal surface (on an upper/maxillary cast replica) of one or more of the replica teeth on the cast replica.

Preferably, the method comprises concentrating the predetermined areas on one or more replica teeth in the posterior sextant of the cast replica. Preferably, the method comprises concentrating the predetermined areas on one or more of the replica molars. Most preferably, the method comprises concentrating the predetermined areas on the last replica tooth, or most distal replica tooth of the cast replica.

Preferably, the method comprises adjusting the surface (adding to the impression, or removing from the cast replica) of each of the predetermined areas by approximately 0.2 mm to approximately 0.6 mm. More preferably, the method comprises adjusting the surface (adding to the impression, or removing from the cast replica) of each of the predetermined areas by approximately 0.4 mm to approximately 0.5 mm. Most preferably, the method comprises adjusting the surface (adding to the impression, or removing from the cast replica) of each of the predetermined areas by approximately 0.5 mm.

Preferably, step (b) comprises shaping a device-forming material over the replica/model. Preferably, the method comprises forming a pre-device from which the device is then shaped. Preferably, the method comprises shaping the material to form a pre-device with at least two of tooth casings. More preferably, with at least four tooth casings. Preferably, the method comprises forming a pre-device with tooth casings for at least one of the posterior teeth on either side. Preferably, the method comprises forming a pre-device with tooth casings for at least one of the pre-molar teeth on either side.

Preferably, the method comprises use of a resiliently flexible material.

The method may comprise using a thermoformable rigid EVA polymer. Preferably, the method comprises using the material in sheet form and thermoforming the sheet over the model.

Alternatively, the method may comprise using an acetylresin material. Preferably, the method comprises injection moulding the acetylresin over the model. With this method, the device can be made in varying thicknesses throughout the arch, allowing optimal aesthetic value. Preferably, a lingual/palatal surface is no thicker than 0.8 mm.

Preferably, the method comprises forming a clip structure from at least one of the tooth casings on either side of the pre-device. Preferably, the method comprises forming the clip structure from the tooth casing or casings comprising the reduced internal dimensions of the predetermined areas (the designated tooth casing(s)).

In the case of a thermoformed pre-device, preferably, the method comprises cutting the clip structure from the formed designated tooth casing.

In the case of an injection moulded pre-device, the method comprises moulding the clip structure as part of the injection process.

Preferably, the method comprises ensuring that the designated tooth casing for each clip is adequately supported by a support structure as part of the device. The method may comprise using an adjacent simulated/replica tooth formed as part of the device as the support structure. Alternatively, the method comprises using an adjacent tooth casing as the support structure. Preferably, the method comprises shaping the designated tooth casing such that each clip encases a lingual/palatal surface and a buccal/facial surface of the respective patient's tooth. Most preferably, the method comprises shaping the designated tooth casing such that each clip partially extends around the mesial surface of the respective patient's tooth. Even more preferably, the method comprises shaping the designated tooth casing such that each clip partially extends around the distal surface of the respective tooth. Preferably, the method comprises shaping both side walls of the designated tooth casing for each clip to extend around the mesial and distal surfaces of the respective tooth and providing openings therebetween at each end. Preferably therefore, the method comprises cutting the designated tooth casing to form an open-ended pincer arrangement for each clip.

The method may comprise avoiding removal of the simulated occlusal surface/wall from the designated tooth casing forming the clip. However preferably, the method comprises removing at least a proportion of the occlusal surface of the designated tooth casing forming each clip to provide a substantially open top side corresponding with an occlusal surface of a patient's tooth.

Preferably, the method comprises using material between approximately 0.5 mm and 1.5 mm in thickness for the clip, most preferably, approximately 1 mm in thickness for the clip.

Preferably, where the dental device comprises one or more tooth casings as simulated teeth (e.g. a veneer), the method comprises using material between approximately 0.5 mm and 1.5 mm in thickness, most preferably, approximately 1 mm in thickness, to correspond to the tooth casings.

Preferably, where the dental device is to function to reduce mouth cavity capacity (e.g. an anti-obesity or slimming device), the method comprises using material up to approximately 15 mm in thickness to cover the palette of the mouth. Preferably, the method comprises using material from approximately 5 mm to approximately 15 mm in thickness to cover the palette of the mouth, most preferably from approximately 10 mm to approximately 15 mm in thickness.

Preferably, the method comprises removal of the material forming the tooth casings that correspond to the occlusal surface(s) of all posterior teeth on the dental device. With this arrangement, mastication is greatly improved when the dental device is in place.

Preferably, the method comprises selection of material to suit the purpose, for example, colour, shade, opacity and texture to best mimic the patient's natural teeth, or to be unseen.

The above method may be suitable where a palatal dental device is required, or no real modification to the shape of the patient's teeth is required. Preferably however, the method comprises the further steps of (i) modifying the cast replica to create a temporary modified model; and (ii) forming a permanent model from the temporary modified model between step (a) and step (b).

In the case of a thermoformed device, in step (i), modification of the cast replica may comprise reconstruction-type work to the replica teeth. Reconstruction work may comprise using a suitable material to build up any missing teeth and/or fill in any cracks, chips, gaps and spaces. The method may use wax. In step (ii) an impression of the temporary model may be taken and the permanent model is created from the model impression.

In the case of an injection moulded device, the method comprises the further steps of (i) modifying the cast replica; and (ii) forming a temporary modified model from the modified replica between step (a) and step (b). In step (i), modification of the cast replica may comprise defining the buccal/palatal and lingual/labial gingival margins. This may comprise creating a groove along said margins. Preferably, the method comprises a further step (iii) in which the temporary model is subject to aesthetic-type work. Aesthetic work may comprise the creation of a desired aesthetic, such as the smile of a famous person, or a “perfect smile”. The method may use wax. In a further step (iv) a counter-replica (other half of the mould) is created using the waxed-temporary model. The modified cast replica (having removed the temporary wax) and the counter-replica may be used as an injection mould for the acetyl resin. Preferably, the method comprises a further step (c) of adapting the fit of the dental device to conform to the patient's teeth. The method may therefore comprise reinstating the original condition of the cast replica from step (i) by removing all of the reconstruction work from the temporary model. A filling material may poured into the inside of the dental device, e.g. into the tooth casings, and applied to the original model until set. With this method, an accurate and comfortable fit to the patient's teeth is achieved.

In a second aspect of the present invention there is provided a non-permanent dental device with improved retention capability on a patient's set of teeth, comprising one or more reduced internal dimensions to produce a tighter fit on the patient's teeth at predetermined retention points or areas.

Preferably, the predetermined retention points or areas are tailored to the individual patient. Most preferably, the predetermined areas correspond to the lingual surface (on a lower/mandibular cast replica), or the palatal surface (on an upper/maxillary cast replica) of one or more teeth.

Preferably, the predetermined areas correspond to one or more teeth in the posterior sextant. Preferably, the predetermined retention points or areas correspond to one or more of the molars. Most preferably, the predetermined areas correspond to the last tooth, or most distal tooth.

Preferably, the reduced internal dimensions of the dental device are therefore smaller internal dimensions than the outer dimension of the corresponding teeth. Preferably, the reduced internal dimensions of the predetermined areas form part of a clip structure around the respective tooth or teeth.

Preferably, each clip structure is moulded internally to the respective tooth. Preferably, each clip structure is integrally formed as part of the device. Preferably therefore, each clip structure is attached to a support structure on the device. The support structure may comprise an adjacent simulated/replica tooth formed as part of the device. Alternatively, the support structure may comprise an adjacent tooth casing or structure.

Preferably, each clip structure is shaped to encase the lingual/palatal surface and the buccal/facial surface of the respective tooth. Most preferably, each clip structure is formed to partially extend around the mesial surface of the respective tooth. Even more preferably, each clip structure is formed to partially extend around the distal surface of the respective tooth. Preferably, both side walls of each clip structure are formed to extend around the mesial and distal surfaces of the respective tooth with openings therebetween at each end. Preferably therefore, each clip structure comprises an open-ended pincer arrangement.

Each clip structure may comprise a simulated occlusal or wall. However, preferably, each clip structure comprises a substantially open top side corresponding with an open occlusal face.

Preferably, the reduced dimension(s) of the device are smaller than the outer dimensions of the corresponding patient's dimensions at the predetermined areas by approximately 0.2 mm to approximately 0.8 mm. More preferably, the reduced dimension(s) of the device are smaller than the outer dimensions of the corresponding patient's dimensions at the predetermined areas by approximately 0.4 mm to approximately 0.6 mm. Most preferably, the predetermined retention points or areas comprise smaller internal dimensions than the outer dimension of the corresponding patient's dimensions by approximately 0.5 mm.

Preferably, the dental device comprises a resiliently flexible material. Preferably, the material comprises a thermoformable rigid EVA polymer or acetylresin.

Preferably, where the dental device comprises one or more simulated teeth (e.g. tooth casings forming a set of veneers), the material corresponding to the simulated teeth is between approximately 0.5 mm and 1.5 mm in thickness, most preferably, approximately 1 mm in thickness.

Preferably, where the dental device is to reduce mouth cavity capacity (e.g. an anti-obesity or slimming device) the material shaped to cover the palette of the mouth is increased up to approximately 15 mm in thickness. Preferably, the material is selected to suit the purpose, for example, colour, shade, opacity and texture to best mimic the patient's natural teeth, or to be unseen.

Preferably, the dental device is adapted to remove the material corresponding to the occlusal surface(s) of the posterior teeth. With this arrangement, mastication is greatly improved when the dental device is in place.

Preferably, dental device is adapted internally to fit around the natural shape of the patient's teeth.

The dental device may be a veneer and/or an anti-obesity or slimming device with a palette portion.

The dental device comprises a natural abutment with the patient's gingival margin.

In a third aspect of the present invention there is provided a non-permanent dental device with improved retention capability on a patient's set of teeth made according to the method of the first aspect of the invention.

In a fourth aspect of the present invention there is provided a non-permanent dental veneer device with improved retention capability on a patient's set of teeth made according to the method of the first aspect of the invention, comprising one or more simulated teeth.

In a fifth aspect of the present invention there is provided a non-permanent dental anti-obesity/slimming device with improved retention capability on a patient's set of teeth made according to the method of the first aspect of the invention, comprising a palette portion to reduce the capacity of the mouth cavity.

It will be appreciated that the preferred features described in relation to the first and second aspects of the invention apply to the third, fourth and fifth aspects of the invention.

### BRIEF DESCRIPTION OF THE DRAWINGS

For a better understanding of the invention, and to show how exemplary embodiments may be carried into effect, reference will now be made to the accompanying drawings in which:

FIG. 1 is a schematic view of a typical upper and lower jaw showing the teeth;

FIG. 2a is a front view of a cast made from an impression from a patient;

FIG. 2b is a front view of the cast of FIG. 2a that has been processed according to the method of the invention;

FIG. 3a is an underside view of the cast of FIG. 2a made from an impression from a patient;

FIG. 3b is an underside view of the cast of FIG. 3a that has been processed according to the method of the invention;

FIG. 4a is a front view of the unprocessed veneer form prepared from the processed cast of FIG. 2b;

FIG. 4b is an underside view of the unprocessed veneer form of FIG. 4a;

FIG. 4c is a front view of the unprocessed veneer cut from the veneer form of FIG. 4a;

FIG. 5a is a perspective side view of a processed veneer made from the unprocessed veneer of FIG. 4c;

FIG. 5b is a perspective upside-down side view of the processed veneer of FIG. 5a;

FIG. 6a is a front view of the processed veneer of FIG. 5a;

FIG. 6b is a front upside-down view of the processed veneer of FIG. 5a;

FIG. 7a is a front view of a patient cast without veneers;

FIG. 7b is a front view of a patient case with veneers;

FIG. 8a is an underside view of a processed veneer of FIG. 5a in place on the cast replica;

FIG. 8b is a bottom-up view of the processed veneer of FIG. 5a;

FIG. 9a is an underside view of a waxed-up duplicate replica that has been processed according to a different embodiment of the method of the invention; and

FIG. 9b is a bottom-up view of a processed veneer made from the duplicate replica of FIG. 9a.

### DETAILED DESCRIPTION OF THE EXEMPLARY EMBODIMENTS

The method of making a non-permanent dental device (10, 100) with improved retention capability on a patient's set of teeth according to the invention, comprises the steps of: (a) preparing a cast replica (20) from an original dental impression taken from the patient; and (b) forming the dental device (10, 100) using the cast replica (20) as a model, wherein the method further comprises reducing one or more dimensions of the cast replica (20) in one or more predetermined retention areas (50).

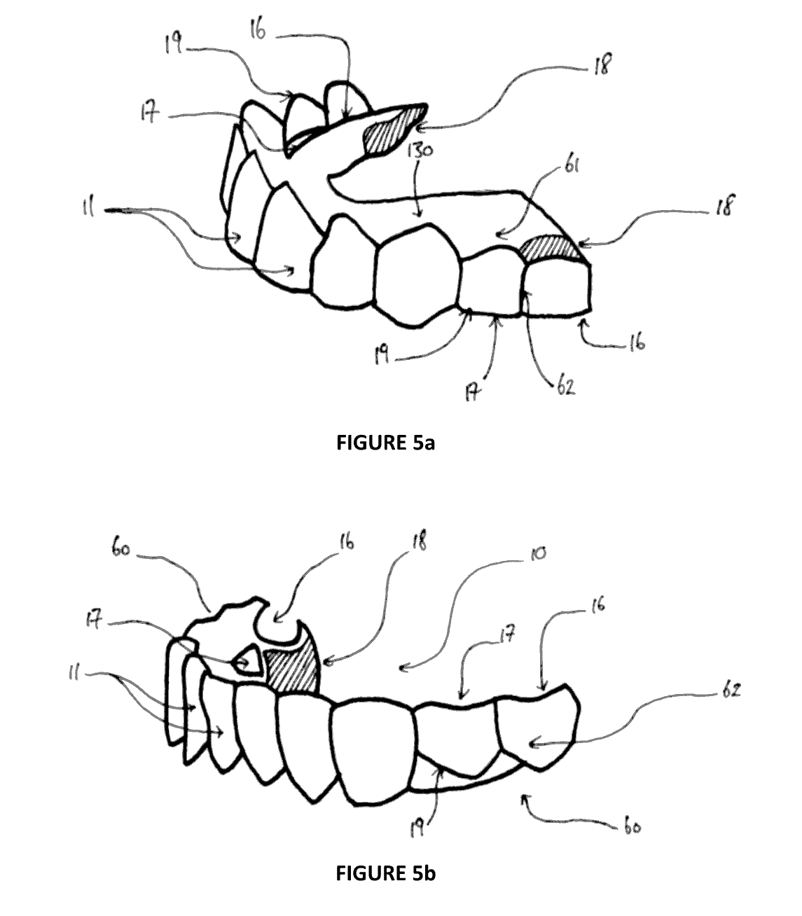

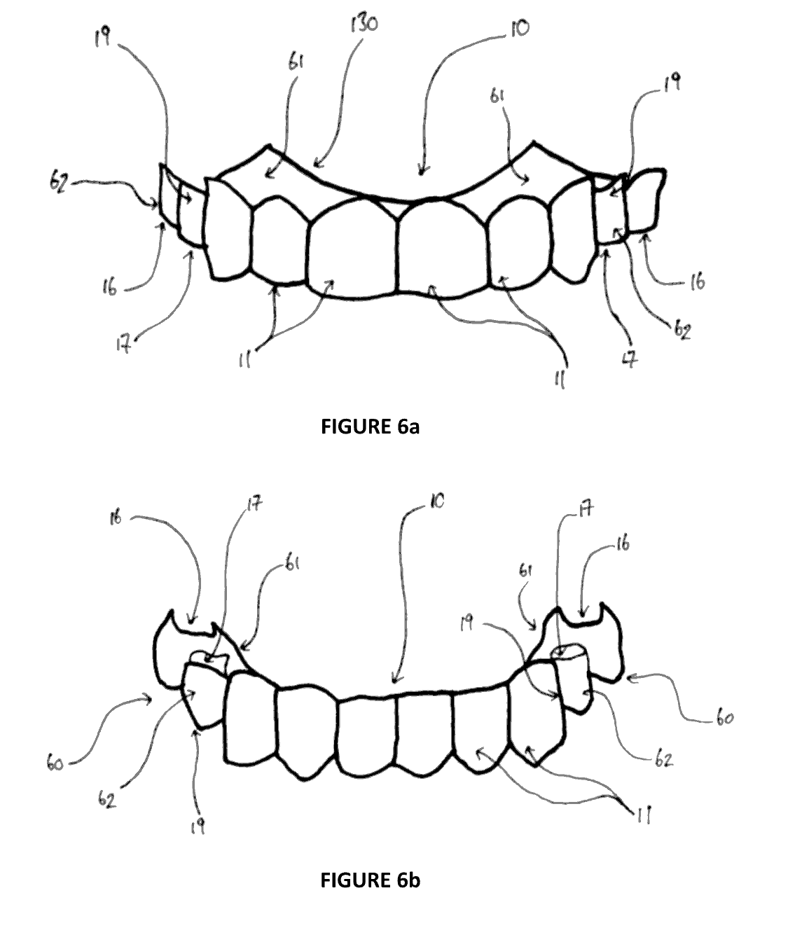

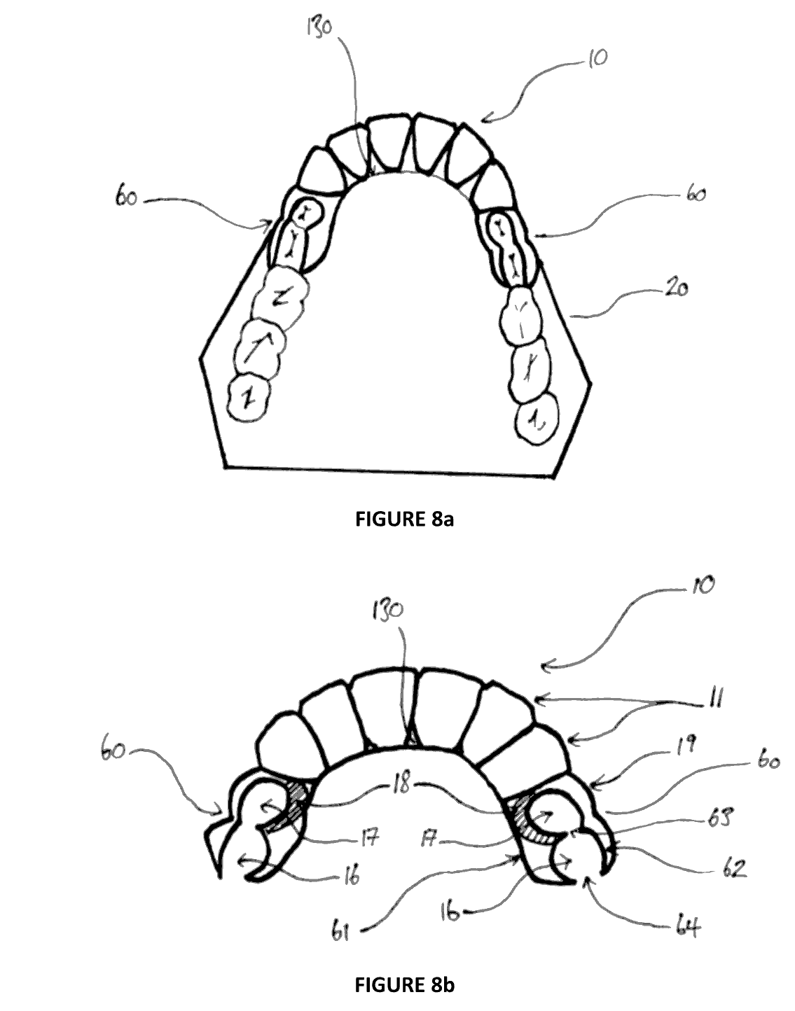

As shown in FIGS. 5, 6, 8 and 9, the method of the present invention generally applies to making of a non-permanent dental device (10, 100) that covers up to the first ten teeth (including the incisors, canines, and pre-molars). If the most distal of the pre-molars (tooth 5) is missing, the dental device (10, 100) would only cover the first eight teeth (to tooth 4). In the instance where the pre-molars (teeth 4 and 5) are completely missing, the dental device (10, 100) would only cover the first six teeth (to tooth 3 on each side).

The conventional process for making a removable/non-permanent dental device (10, 100) which will fit over a patient's teeth comprises the following steps.

1) A Dental Impression is Taken from a Patient (Not Shown).
The impression is taken using a very precise impression material loaded into a bite tray, which is then applied to the patient's teeth and held there until set (usually 3-5 minutes depending upon the impression material used). It is usually very important that the impression is clear and accurate, preferably with no drag.

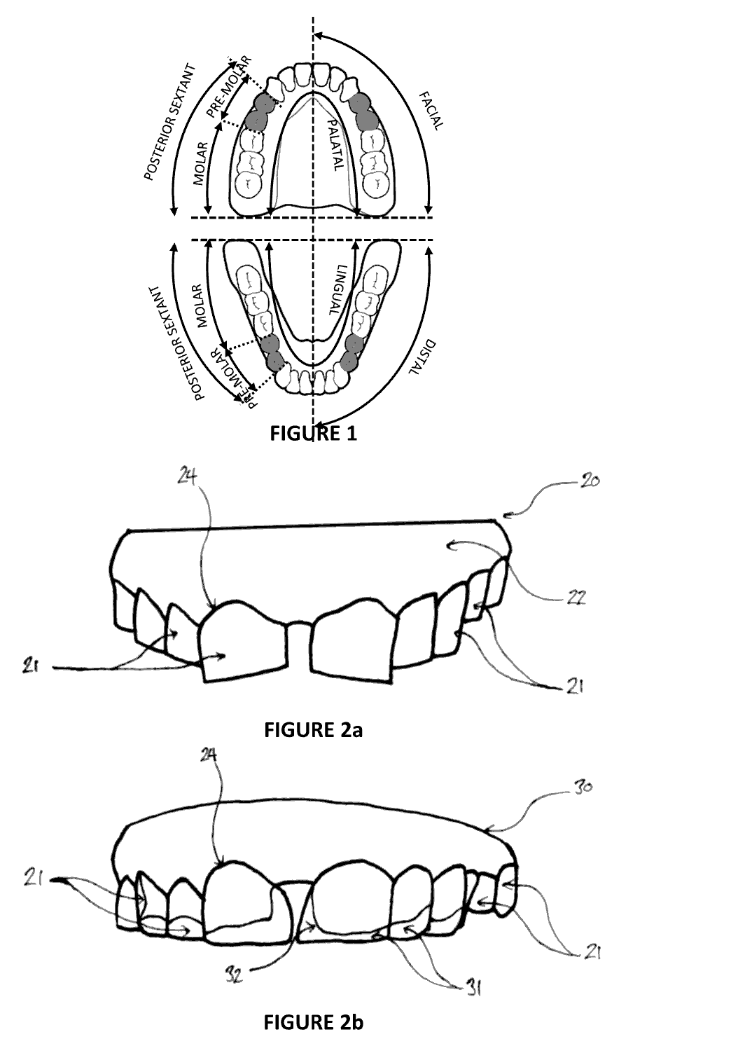

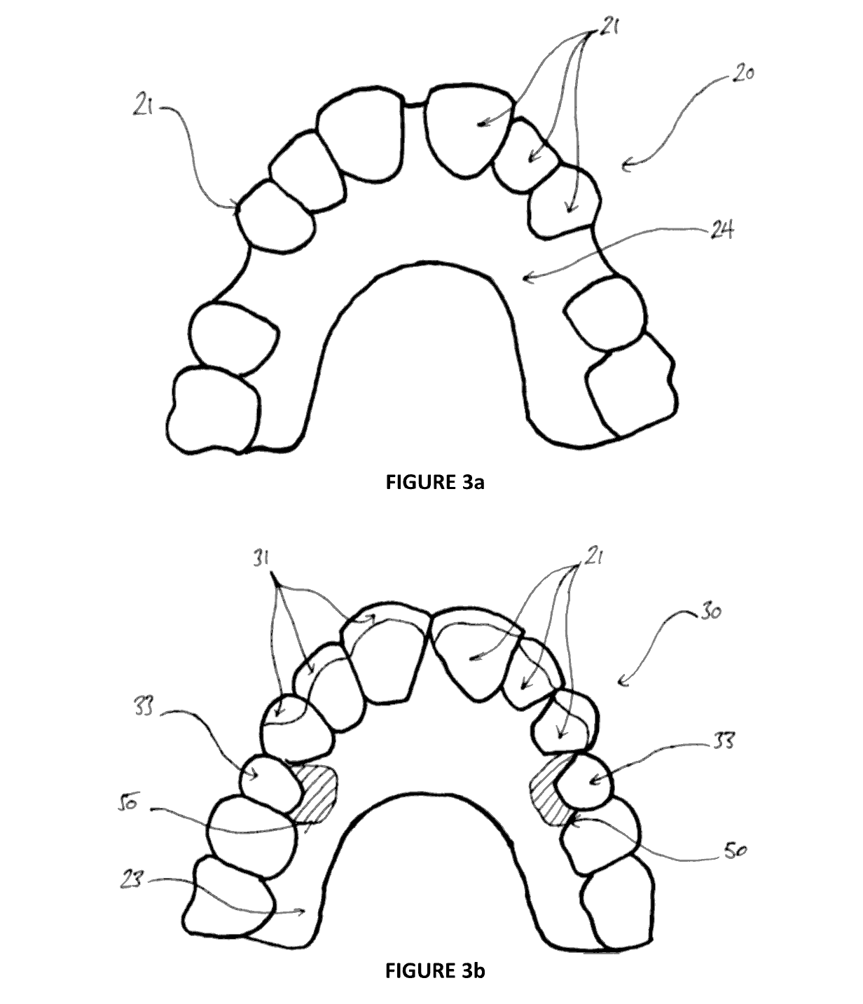

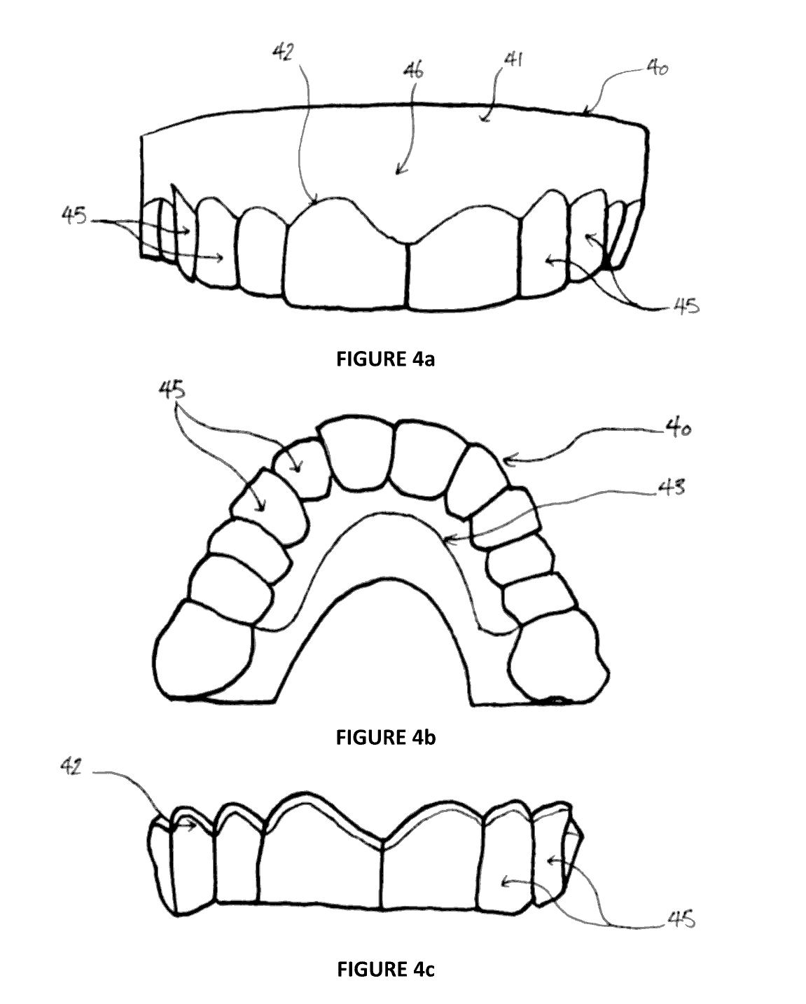

2) Preparing a Cast Replica (20) of the Patient's Teeth.
In accordance with conventional practice, this is done by pouring casting material into the impression and allowed to set. Once set, the cast is removed from the impression and trimmed of the excess material to create the cast replica (20). A cast replica (20) is shown in FIGS. 2a and 3a and comprises replica teeth (21), the replica gum (22), the peripheral palatal or lingual surface (23) and the gingival margins (24, 25).

3) Modifying the Cast Replica (20) to Create a Temporary Modified Model (30).
During this step, reconstruction work is performed on the cast replica (20) using wax to build up any teeth (as at 31) and fill in any cracks, chips, gaps and spaces (32). If there are teeth missing these are usually filled using preformed acrylic denture teeth (33). The wax is not be applied to the gingival margins (24, 25). The end of an Ash 5 is used to scrape along the replica buccal/palatal and lingual/labial gingival margins (24, 25) making the insertion as smooth as possible to distinguish the replica teeth (21) from replica gum (22) more clearly. If there is any drag on the cast replica (20) it is removed at this stage to form the temporary modified model (30).

4) Forming a Permanent Model (Not Shown) from the Temporary Modified Model (30)
A (second) impression (not shown) of the temporary modified model (30) is taken. This is done using an impression tray similar to the method in step 1, but instead performed upon the temporary modified model (30). The second impression is checked for imperfections and corrected accordingly. The permanent model is created from the second impression, by pouring casting material into the second impression and allowing to set. Once the impression material is set, the permanent model is removed from the second impression and trimmed of excess material.

5) Forming the Pre-Device (40).
This is done using the permanent model or, if there is no permanent model (usually because no reconstruction work is required) from the cast replica (20). The correct shade of device-forming material (41) is selected and laid over the cast replica (20)/permanent model and thermoformed using a Dreve or equivalent Pressure Former. The pre-device (40) comprises at least a number of tooth casings (45) that correspond to simulated teeth surrounded by excess material (46).

6) Shaping the Pre-Device (40) to Form the Device (10).
Whilst the pre-device (40) is still in situ on the cast replica (20)/permanent model, an ultra-fine tip marker is used to:
   (a) draw (42) along the buccal/labial gingival margin (24), and
   (b) draw a straight line (43) 2 mm below the gingival margin (25) along the palatal/lingual part of the pre-device (40).
The device (10) is then lifted off the cast replica (20)/permanent model. Using a pair of Quinby scissors or equivalent the device (10) is cut 1 mm below the drawn lines (42, 43).
The device (10) comprises a number of connected tooth casings/simulated teeth (11).

7) Adapting the Fit of the Device (10) to the Patient's Teeth.
The temporary modified model (30) from step 3 is taken back to its original cast replica (20) state by removing all of the reconstruction wax material (31, 32) and acrylic teeth (33), typically by boiling off/steaming off all the wax. Any undercuts are blocked out and any preformed acrylic teeth that formed part of the temporary modified model (30) are placed in the correct place within the device (10).
A filling material, usually a cold curing acrylic, is poured into the inside of the dental device (10) (e.g. inside the tooth casings (11)) and then the dental device (10) is quickly applied to the cast replica (20) and secured. It is important to remove any excess acrylic immediately and then the device (10) is placed in a warm Hydraflask until the acrylic is set. The adapted device (10) is then taken off the original cast replica (20).

8) Finishing the Dental Device (10).
The edges of the device (10) are smoothed and the surface is polished to give a comfortable fit.

### Specific Method Steps According to a First Embodiment of the Present Invention

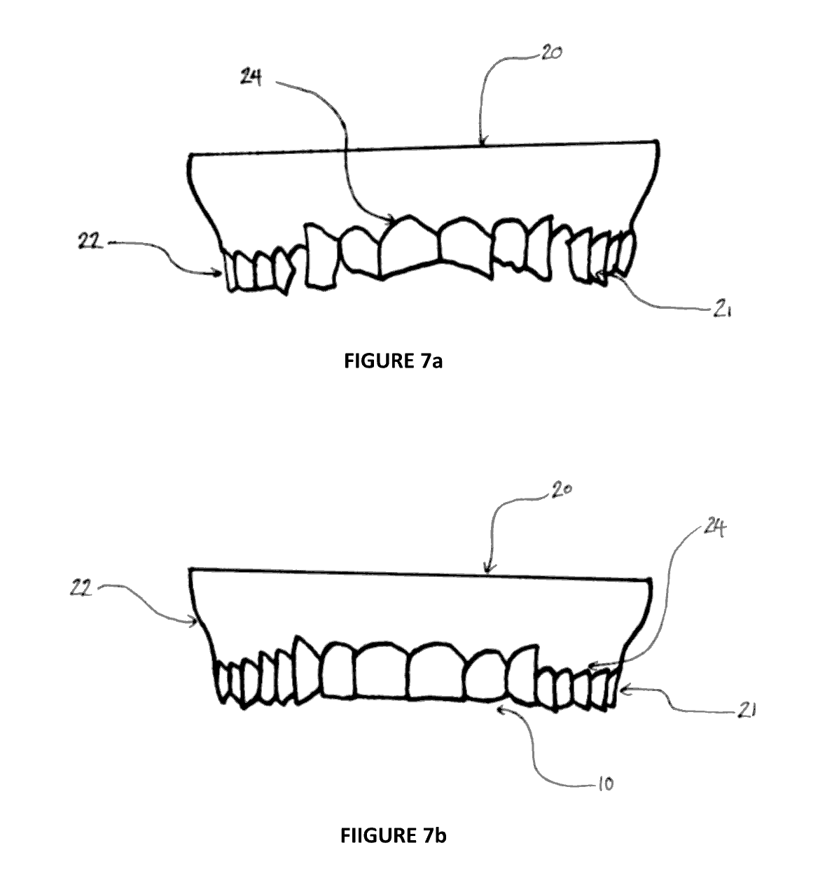

The method of the present invention improves on the conventional method by adapting certain method steps and adding new steps to produce a first type of device (10) as shown in FIGS. 5, 6, 7 and 8.

Step 1—A Dental Impression is Taken from a Patient (Not Shown)

This step is the same as described in the conventional method.

Step 2—Preparing a Cast Replica (20) of the Patient's Teeth

This step is the same as described in the conventional method.

Between Steps 2 and 3—Reducing One or More Dimensions of the Prepared Cast Replica (20).

In the present invention, an additional method step is employed between steps 2 and 3 in which one or more dimensions of the prepared cast replica (20) are reduced.

In one specific embodiment of the present invention, this is achieved by shaving away 0.5 mm of cast material from the surface at predetermined areas (50) on the cast replica (20).

In a different embodiment of the present invention, the reduced dimension(s) is/are achieved by the addition of 0.5 mm impression material to the patient's impression (not shown) in step 1 at predetermined areas (not shown) that correspond to the predetermined areas (50) on the cast replica (20). This results in a cast replica (20) with reduced dimensions (by 0.5 mm) in the predetermined areas (50).

In either of the two embodiments, the predetermined areas (50) correspond to the lingual surface (on a lower/mandibular cast replica), or the palatal surface (on an upper/maxillary cast replica) of one or more teeth. As shown in FIG. 3b, in an exemplary embodiment, the predetermined area corresponds to the lingual surface (on a lower/mandibular cast replica), or the palatal surface (on an upper/maxillary cast replica) of the final tooth (tooth 5). In any event this adaptation will apply to the last available tooth, or the penultimate tooth.

With the addition of this method step, the resultant dental device (10) is slightly smaller and therefore, tighter around the patient's teeth at predetermined areas (18) on the device (10) that correspond to the predetermined areas (50) on the cast replica (20).

In use, due to the method steps employed, the whole device (10) is a snug fit against the contours of the patient's teeth, gingival margins and palatal/labial gum. However, due to the resiliently deformable characteristics of the material (41) used, when the device (10) is being fitted, the smaller predetermined areas (18) of the device (10) are able to flex and slide over the respective patient's teeth. The predetermined areas (18) click firmly into position over the patient's corresponding teeth to give a durable retentive fit. The device (10) therefore, provides greatly improved retention performance.

Step 3—Modifying the Cast Replica (20) to Create a Temporary Modified Model (30)

This step is the same as described in the conventional method.

Step 4—Forming the Permanent Model.

The best result to establish a permanent model has been found using a medium impression tray and Zhermacks Hydrogum 5 alginate. Once the impression is set, a debubbiliser is used prior to casting the permanent model therefrom.

Step 6—Forming the Clip (60).

During shaping of the device (10), a clip (60) is formed from the last replica/simulated teeth/tooth casings on both sides of the device (10). Each clip (60) is integrally moulded as part of the device (10) and is therefore attached to an adjacent support structure (19) on the device (10). The support structure (19) will depend upon the individual patient's teeth and how many teeth the device (10) is being made to cover. The support structure (19) will usually comprise an adjacent simulated/replica tooth formed as part of the device (10), or an adjacent tooth cover. The support structure (19) may comprise a simulated tooth, or veneer (tooth casing (11)) for an adjacent tooth.

Each clip (60) is shaped to encase the lingual/palatal surface and the buccal/facial surface of the respective tooth. Therefore, each clip (60) is cut from the pre-device (40) to define two side walls (61, 62) to provide a lingual/palatal wall (61) and a buccal/facial wall (62) respectively. During cutting, care is taken to ensure that the side walls (61, 62) curve around to encompass the available portions of the mesial and distal walls of the tooth casings (11).

The lingual/palatal side wall (61) on each clip comprises the predetermined area (18).

During moulding, it may be that openings (63, 64) are automatically provided at either end of the walls (61, 62), although, cutting of the device (10) may be required to free the distal end of the clip (60).

Each clip (60) may be left with a simulated occlusal surface or wall. However, in a preferred embodiment, each clip (60) is freed of the replica occlusal surface to leave an open top side.

With this configuration, the clips (60) are provided with a greater degree of flexibility to facilitate fitting, but allow for the improved retention performance.

Step 8—Finishing the Device

It is important to ensure that the finished device (10) is comfortable to wear for long periods of time. Therefore, the following steps are performed:
a) a Queenie point or Rubber polisher is used to smooth and shape all edges.
b) a white lisko (fine) is lightly moved over the edges.
c) a scalpel is used to cut any excess material off.
d) a fine diamond disc is used to lightly separate each tooth individually.
e) an orange lisko (ultra-fine) is used over all edges.

Additional Step

In another embodiment of the present invention, replica occlusal surfaces (not shown) that cover the patient's pre-molar teeth are provided on the device (10) as part of the process.

Prior to the finishing step 8, the replica occlusal surfaces are cut away using a tungsten carbide bur to provide openings (16, 17) in the device (10). Accordingly, the patient's occlusal surfaces are uncovered when the device (10) is worn, and so there is no inhibition to chewing.

### Specific Method Steps According to a Second Embodiment of the Present Invention

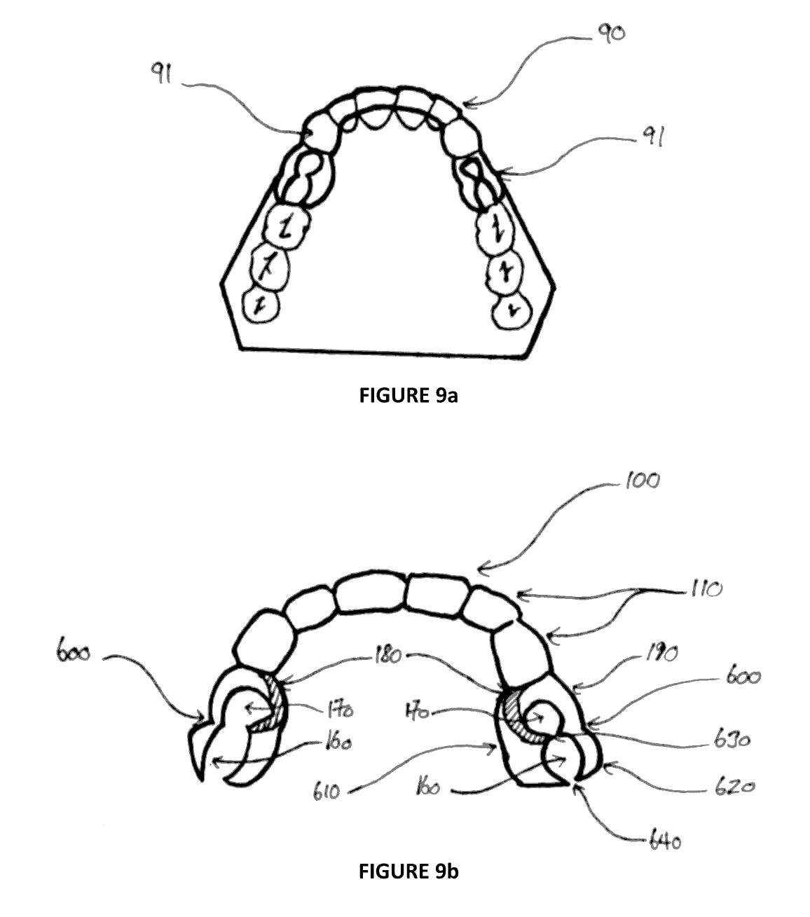

The method of the present invention improves on the conventional method by adapting certain method steps and adding new steps to produce a second type of device (100) as shown in FIG. 9b-c.

Step 1—A Dental Impression is Taken from a Patient (Not Shown)

This step is the same as described in the conventional method.

Step 2—Preparing a Cast Replica (20) of the Patient's Teeth

This step is the same as described in the conventional method. The casting material is chosen specifically to be suitable for use with acetyl resin.

Between Steps 2 and 3—Reducing One or More Dimensions of the Prepared Cast Replica (20).

As discussed in relation to the first embodiment of the invention, in the present embodiment, an additional method step is employed between steps 2 and 3 in which one or more dimensions of the prepared cast replica (20) are reduced.

Step 3—Modifying the Cast Replica (20)

Modification of the cast replica (20) comprises defining the buccal/palatal and lingual/labial gingival margins with the Ash 5 scrape as before. However, no reconstruction work is performed at this stage.

Step 3—Modifying the Cast Replica (20) to Create a Temporary Modified Model (90)

In this step, as shown in FIG. 9a, the cast replica (20) is waxed up by applying wax (91) to create a temporary modified model (90). The wax (91) is intended to model a desired aesthetic, such as the smile of a famous person, or a “perfect smile”. Therefore, the application of the wax (91) is accurately performed on the model (90) to reflect the shape, size and configuration of the final device (100).

Step 4—Forming the Permanent Model.

This step is adapted considerably to prepare for an injection moulding process using an injection moulding machine. The end result is a permanent injection mould.

Using a two part dental flask that is applicable to a particular injection moulding machine, the temporary modified model (90) is sunk into one half of the flask. The flask is then closed on the temporary modified model (90). The flask is filled with plaster and left to set.

Once set, the flask is opened and the wax is boiled away from the temporary modified model (90) to revert back to the cast replica (20), which remains embedded in the flask.

Step 5—Forming the Pre-Device

The flask is once again closed and the injection process is performed. The injection mould is left to set and cool before de-flasking takes place.

Step 6—Shaping the Pre-Device (40) to Form the Device (10).

Since the device (100) was injection moulded using the cast replica (20) of the patient's teeth, the external configuration of the device (100) is already shaped and so no further significant shaping is necessary.

Step 7—Adapting the Fit of the Device (100) to the Patient's Teeth

Since the device (100) was injection moulded using the cast replica (20) of the patient's teeth, the internal configuration of the device (100) is already adapted to the patient's teeth and so no further adaptation is necessary.

Step 8—Finishing the Device (100).

It is important to ensure that the finished device (10) is comfortable to wear for long periods of time and aesthetically accurate. Therefore, the following steps are performed:
a) the device (100) is de-flasked carefully.
b) the device (100) is eased onto the original cast replica (20).
c) a white lisko (fine) is lightly moved over the edges.
d) a scalpel is used to cut any excess material off.
e) a fine diamond disc is used to lightly separate each tooth individually.
f) an orange lisko (ultra-fine) is used over all edges.
g) The device (100) is polished to a high sheen.

The above method provides a preferred device (100) with exceptional aesthetic characteristics, durability and retention performance.

During injection moulding of the device (100), a clip (600) is formed from the last replica/simulated teeth/tooth casings on both sides of the device (100). Each clip (600) is integrally moulded as part of the device (100) and is therefore attached to an adjacent support structure (190) on the device (100). The support structure (190) will depend upon the individual patient's teeth and how many teeth the device (100) is being made to cover. The support structure (190) will usually comprise an adjacent simulated/replica tooth formed as part of the device (100), or an adjacent tooth cover. The support structure (190) may comprise a simulated tooth, or veneer (tooth casing (110)) for an adjacent tooth.

Each clip (600) is shaped to encase the lingual/palatal surface and the buccal/facial surface of the respective tooth. Therefore, each clip (600) is moulded to define two side walls (610, 620) to provide a lingual/palatal wall (610) and a buccal/facial wall (620) respectively. During cutting, care is taken to ensure that the side walls (610, 620) curve around to encompass the available portions of the mesial and distal walls of the tooth casings (110). The lingual/palatal side wall (610) on each clip comprises the predetermined area (180).

During moulding, openings (630, 640) are automatically provided at either end of the walls (610, 620), although, cutting of the device (100) may be required to free the distal end of the clip (600). Each clip (600) is freed of the replica occlusal surface to leave an open top side. With this configuration, the clips (600) are provided with a greater degree of flexibility to facilitate fitting, but allow for the improved retention performance.

The device (100) is made from crystallized acetyl resin, which is very durable and has a slight flexibility. The flexibility allows the device (100) to flex over the heights and contours of the existing teeth and snap back onto the gingival third of the teeth. A device (100) formed from this resin is expected to last about 3 to 5 years and possibly longer with proper care.

During the method, the carving (in step 3) of the labial/palatal wall of the last tooth enhance the clip (600) function. This is helpful in cases where there are multiple missing teeth, since the device (100) can surround the abutment tooth/teeth circumferentially, utilizing not only the buccal and lingual aspects of the teeth, but also the mesial and distal aspects, and obtain almost the same retention performance.

Specific Devices Made According to the Present Invention

The present invention provides a non-permanent dental device (10, 100) with improved retention capability on a patient's set of teeth, comprising one or more reduced internal dimensions to produce a tighter fit on the patient's teeth at predetermined retention points or areas (18, 180).

The predetermined retention points or areas (18, 180) provide a tighter fit. The location of the areas (18, 180) are tailored to the individual patient depending upon the teeth that are available, but as shown in FIGS. 5-8 and in most circumstances, the areas (18, 180) correspond to the lingual surface (on a lower/mandibular cast replica), or the palatal surface (on an upper/maxillary cast replica) of the most distal pre-molar (tooth 5) on each side of the mouth.

The reduced dimension(s) of the device (10, 100) are smaller than the outer dimensions of the corresponding patient's dimensions at the predetermined areas (18, 180) by approximately 0.5 mm and the device (10, 100) is formed from a resiliently deformable/flexible material.

Each of the predetermined areas (18, 180) forms part of a clip (60, 600) that is shaped to encase the lingual/palatal surface and the buccal/facial surface of the respective tooth. Therefore, each clip (60, 600) defines two side walls (61/610, 62/620) to provide a lingual/palatal wall (61, 610) and a buccal/facial wall (62, 620) respectively. Each of the side walls (61/610, 62/620) curves around to encompass the available mesial and distal surfaces of the respective tooth.

The lingual/palatal side wall (61, 610) on each clip comprises the predetermined area (18, 180).

During moulding, it may be that openings (63/630, 64/640) are automatically provided at either end of the walls (61/610, 62/620), although cutting of the device (10, 100) may be required to free the distal end of the clip (60, 600) and provide the opening (64, 640).

Each clip (60, 600) may be left with a simulated occlusal surface or wall. However, in a preferred embodiment, each clip (60, 600) is freed of the replica occlusal surface to leave an open top side.

The replica occlusal surfaces are cut away to provide openings (16/160, 17/170) in the device (10,100). With this arrangement, mastication is greatly improved when the dental device is in place.

The dental device (10, 100) comprises a natural abutment with the patient's gingival margin.

Veneers

In one embodiment of the invention as shown in FIGS. 5-8, the device (10, 100) is a non-permanent set of veneers comprising a plurality of simulated teeth (tooth casings) or veneers (11, 110), a peripheral palatal or lingual surface (13, 130), and clips (60, 600) comprising the predetermined areas (18, 180). The material corresponding to the simulated teeth (11, 110), the palatal or lingual surface (13, 130), the clips (60, 600) and the predetermined areas (18, 180) is approximately 1 mm in thickness.

The result is a non-permanent dental veneer device (10, 100) with improved retention capability on a patient's set of teeth comprising one or more simulated teeth/tooth casings (11, 110).

Anti-Obesity/Slimming Device

In another embodiment of the present invention the device (10, 100) is a non-permanent dental anti-obesity/slimming device comprising a palatal surface portion that covers a significant portion of the patient's palate, and also comprising the clips (60, 600) comprising the predetermined areas (18, 180) as before. The material corresponding to the clips (60, 600) and the predetermined areas (18, 180) is approximately 1 mm in thickness, although the palette is increased up to approximately 15 mm in thickness.

The increase in the palette thickness is achieved using the “Salt and Pepper” method (alternating application of a monomer (liquid) and a polymer (powder) in the following steps (to be completed in a timescale of 3-4 minutes to avoid porous acrylic):
1. Apply a small amount of separator to a lingual side of the palette on the device (10, 100) with a separator brush and spread it evenly;
2. Secure wires into place on the buccal side of the device (10, 100) with wax, using a #7 wax spatula.
3. Hold the device (10, 100) model slightly tilted toward the side acrylic resin will be applied and apply a thin layer of polymer (powder).
4. Powder along the lingual tooth surfaces of the device (10, 100) to the middle of the palette.
5. Apply several drops of monomer (liquid) until the polymer has been absorbed by monomer.
6. Repeat steps 3-5 using thin layers of monomer/polymer until the palette is approximately 3-4 mm thick.
7. Spray a very light film of polymer on the palette so that the acrylic will not run down the vault of the palate.
8. Turn the device over and repeat steps 3-7 until the other side of the palette is also approximately 3-4 mm thick.
9. Place the device (10, 100) in a heated pressure pot with 20 pounds of air pressure for 10-15 minutes to allow the acrylic to cure.

The method and the devices made according to the invention provide improved retention performance when compared with devices made according to other methods. The whole device (10, 100) provides a snug fit against the contours of the patient's teeth, gingival margins and palatal/labial gum. However, due to the resiliently deformable characteristics of the material (41) used, when the device (10, 100) is being fitted, the clips (60, 600) comprising the predetermined areas (18, 180) of the device (10, 100) are able to flex and slide over the respective patient's teeth. The clips (60, 600) click firmly into position over the patient's corresponding teeth and deliver a tighter fit due to the reduced dimensions provided by the altered predetermined areas (18, 180) to give a durable retentive fit. The device (10, 100) therefore, provides greatly improved retention performance.

Although a few preferred embodiments have been shown and described, it will be appreciated by those skilled in the art that various changes and modifications might be made without departing from the scope of the invention, as defined in the appended claims.

1-32. (canceled)

33. A method of making a non-permanent dental device with improved retention capability on a user's set of teeth, comprising the steps of:
preparing a cast replica from an original dental impression taken from the user;
modifying the cast replica to create a temporary modified model by at least reducing one or more dimensions of the cast replica in one or more predetermined retention areas;
forming a permanent model from the temporary modified model; and
forming the dental device from the permanent model.

34. The method of claim 33 wherein modifying the cast replica further comprises defining buccal or palatal and lingual or labial gingival margins by creating a groove along said margins in the case replica.

35. The method of claim 33 further comprising the step of forming a pre-device from the permanent model, the pre-device having at least two tooth casings.

36. The method of claim 35 wherein the pre-device comprises a clip structure associated with each of the at least two tooth casings, each clip structure having an open-ended pincer arrangement.

37. The method of claim 36 further comprising the step of removing at least a portion of a simulated occlusal surface from the clip structure.

38. The method of claim 33 wherein modifying the cast replica further comprises adding approximately 15 mm of material to a form a pallette portion of the device between the predetermined retention areas designed to align with the palette of the user's mouth.

39. The method of claim 33 wherein the device is thermoformed, and wherein the cast replica is modified using wax.

40. The method of claim 33 wherein the device is injection molded, and wherein the device is made of acetyl resin.

41. The method of claim 36 further comprising the step of shaping the at least two tooth casings such that each clip partially will extend around a mesial surface of the user's tooth.

42. The method of claim 40 further comprising the step of creating a counter-replica mold using the temporary modified model.

43. The method of claim 38, wherein adding the material comprises the alternating steps of adding a powder polymer and adding a liquid monomer.

44. The method of claim 43 further comprising the step of placing the device in a heated pressure pot for 10-15 minutes for curing.

45. A customized dental device for placement over a user's natural teeth, the device comprising:
at least two tooth casings corresponding to teeth on opposing sides of a user's mouth;
retention features formed in predetermined retention areas that provide an interference fit to a user's molar teeth on opposing sides of the user's mouth without contacting the gingiva;
a thickened pallette portion extending between the at least two tooth casings corresponding to the user's pallette; and
a groove along gingival margins;
wherein the device is formed using the steps of:
preparing a cast replica from an original dental impression taken from the user;
modifying the cast replica to create a temporary modified model;
forming a permanent model from the temporary modified model; and
forming the dental device from the permanent model.

46. The customized dental device of claim 45, further comprising a clip structure associated with each of the at least two tooth casings, each clip structure having an open-ended pincer arrangement.

47. The customized dental device of claim 45, wherein the device is thermoformed, and wherein the cast replica is modified using wax.

48. The customized dental device of claim 45, wherein the device is injection molded, and wherein the device is made of acetyl resin.

49. The customized dental device of claim 46, wherein each clip is formed to partially extend around a mesial surface of the user's corresponding teeth.

50. The customized dental device of claim 45, wherein the thickened pallette portion is formed by alternating steps of adding a powder polymer and adding a liquid monomer.
